(19) United States
(12) Patent Application Publication
(10) Pub. No.: US 2024/0184134 A1
(43) Pub. Date: Jun. 6, 2024

(54) DUAL-AXIS HINGE MECHANISM

(71) Applicant: Apple Inc., Cupertino, CA (US)

(72) Inventors: Jonathan M. Anderson, Mountain View, CA (US); John Raff, Menlo Park, CA (US); Teodor Dabov, San Francisco, CA (US)

(21) Appl. No.: 18/441,933

(22) Filed: Feb. 14, 2024

Related U.S. Application Data
(63) Continuation of application No. PCT/US2022/075298, filed on Aug. 22, 2022.
(60) Provisional application No. 63/260,587, filed on Aug. 26, 2021.

(51) Int. Cl. G02C 5/22

(52) U.S. Cl. CPC G02C 5/2209

(57) ABSTRACT

Eyewear includes a frame connected to an arm using a hinge mechanism that enables movement of the arm to a folded position, a nominal position, and a hyperextended position. In the nominal position, gaps and exposure of any electronic components of the eyewear are minimized or eliminated. A hinge with multiple axes of rotation of different parts allows the arm to automatically snap between multiple stable positions relative to the frame while also being able to flex and apply a clamping force to a wide array of heads. A cable or other electrical connector can extend through a portion of the hinge to protect and guide the cable between electronic parts in the arm and frame.

### CROSS-REFERENCE TO RELATED APPLICATION(S)

This is a continuation of International Patent Application No. PCT/US2022/075298, filed 22 Aug. 2022, and entitled “DUAL-AXIS HINGE MECHANISM,” which claims priority to U.S. Provisional Patent Application No. 63/260,587, filed 26 Aug. 2021, and entitled “DUAL-AXIS HINGE MECHANISM,” the entire disclosure of which is hereby incorporated by reference.

### FIELD

The described embodiments relate generally to eyewear frames and hinges. More particularly, the present embodiments relate to hinges for electronic eyewear.

### BACKGROUND

Hinges of eyewear are common points of failure and nuisance for manufacturers and wearers. There is a constant need for improvements to eyewear comfort, aesthetics, quality, manufacturing efficiency, and durability, especially with respect to the hinges incorporated in eyewear bearing electronic components.

### SUMMARY

An aspect of the present disclosure relates to electronic eyewear including a frame containing a light emitter and a waveguide to direct light from the light emitter, where the frame has a first surface. An arm can also be included and can have a second surface, and a hinge can pivotally join the frame and the arm. The hinge can include a first axis of rotation and a second axis of rotation.

In some examples, the electronic eyewear can further include a first central axis normal to the first surface and a second central axis normal to the second surface. According to some examples, with the hinge in a first open position, the first surface is parallel to the second surface and the first central axis is parallel to the second central axis. In other examples, with the hinge in a second open position, the first surface is non-parallel to the second surface and the second central axis is translated relative to the first central axis.

In some embodiments, the hinge includes a torque profile configured to automatically move to the folded position and to automatically move to the first open position. The hinge can include a cam and a support surface, with the cam having a first flat surface and a second flat surface, wherein the first flat surface engages the support surface with the hinge in the folded position. The second flat surface can engage the support surface with the hinge in the first open position. In some embodiments, the first and second flat surfaces are out of contact with the support surface with the hinge in the second open position. The hinge can include a first portion inserted into a second portion, with the first portion having a first curved exterior surface and with the second portion having a second curved exterior surface. The first and second curved exterior surfaces can be vertically aligned when the hinge is in the first open position.

The hinge can include a spring member to bias the first surface and the second surface to the first open position from the second open position. The hinge can also include a first rotation axis and a second rotation axis, wherein the hinge rotates about the first rotation axis when moving from the folded position to the first open position, and wherein the hinge rotates about the second rotation axis when moving from the first open position to the second open position.

In some embodiments, the frame has a frame lateral side surface and the arm has an arm lateral side surface, wherein in the second open position, the arm lateral side surface is positioned laterally external to the frame lateral side surface.

Another aspect of the disclosure relates to a hinge for glasses including a first hinge portion defining a cam support surface and a rotation assembly, with the rotation assembly including a spring, a shaft, and a linkage; and a second hinge portion defining a cam rotatably coupled with the linkage and having a first flat surface and a second flat surface. The spring is configured to bias the cam to rotate about the shaft toward the cam support surface via the linkage. Additionally, the cam can be rotatable between a first position and a second position such that in the first position the first flat surface engages the cam support surface, and in the second position the second flat surface engages the cam support surface.

In some embodiments, the cam can include a second shaft coupled to the linkage. The rotation assembly can further include a second linkage rotatably coupled with the cam, wherein the linkage is positioned opposite the first and second flat surfaces relative to the second linkage. In some embodiments, the cam includes a hard stop surface configured to stop rotation of the cam relative to a stop surface of the first hinge portion. The cam can have an internal channel, wherein a cable is routable between the first and second hinge portions through the internal channel. The cam can be rotatable about the shaft to a third position with the first and second flat surfaces spaced away from the cam support surface. The spring can bias the first and second flat surfaces toward the second position from the third position.

Yet another aspect of the disclosure relates to electronic glasses including an arm structure having a first electronic component, a protrusion, and an aperture defined through the protrusion; a frame structure having a second electronic component and a recess receiving the protrusion, wherein the protrusion is rotatable relative to the recess between a folded position and an unfolded position; and a cable connecting the first and second electronic components, with the cable being contained by the aperture and the recess in the folded position and in the unfolded position.

In some embodiments, the glasses can further include a flexible seal, wherein the cable includes a longitudinal axis, and wherein the cable is configured to translate along the longitudinal axis to flex the flexible seal. The protrusion can include a curved surface, wherein the frame structure includes a rounded external surface, and wherein the curved surface and the rounded external surface have matching curvature at least in the unfolded position. The cable can bend at least twice within the aperture. Furthermore, the aperture can have a recess portion in which the cable is positioned, wherein a rotation axis of the protrusion extends through the recess portion.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a top view of eyewear with its arms in a folded condition.

FIG. 2 shows a side view of the eyewear with its arms in partially unfolded and unfolded/nominal positions.

FIG. 3 shows an internal rear perspective view of a hinge of the eyewear in a nominal position.

FIG. 4 shows an external rear perspective view of the hinge of the eyewear in a folded position.

FIG. 5 shows a top view of a hinge of the eyewear in a nominal position.

FIG. 6 shows a top view of the hinge in a hyperextended position.

FIG. 6A shows a detail view of FIG. 6.

FIG. 7 shows a perspective view of portions of the hinge in a nominal position.

FIG. 8 shows a perspective view of portions of the hinge in a nominal position with the arm and frame shown in broken lines.

FIG. 9 shows a perspective view of portions of the hinge in a folded position with the frame partially shown in broken lines.

FIG. 10 shows a top section view as taken through section lines 10-10 in FIG. 9.

FIG. 11 shows a simplified top section view of the hinge in a nominal position.

FIG. 12 shows a simplified top section view of the hinge in a folded position.

FIG. 13 shows a simplified top section view of the hinge in a hyperextended position.

FIG. 14 shows a chart of torque profiles of a hinge of the eyewear while unfolding and folding.

FIG. 15 shows a chart of a clamping force to angular displacement relationship for the eyewear in hyperextension.

FIG. 16 shows a perspective top view of a cam portion of the hinge of the eyewear.

FIG. 17 shows a simplified top view of a cable routed through the hinge of the eyewear.

FIG. 18 shows a simplified side section view of the hinge and cable routing as taken through section lines 18-18 in FIG. 17.

### DETAILED DESCRIPTION

Reference will now be made in detail to exemplary embodiments illustrated in the accompanying drawings. It should be understood that the following descriptions are not intended to limit the embodiments to one preferred embodiment. Rather, it is intended to cover alternatives, modifications, and equivalents as can be included within the spirit and scope of the described embodiments as defined by the appended claims.

The following disclosure relates to eyewear worn on a user's head that has a frame configured to be positioned in front of the eye(s) and an arm connected to the frame by a hinge that allows the arm to fold into a storage position relative to the frame. The hinge is configured to automatically move to two different stable positions relative to the frame, such as, for example, the folded position with the arm at an about 90-degree angle relative to a projection portion of the frame to which the hinge is connected, and a nominal, open, or unfolded position wherein the arm extends at an about 180-degree angle relative to the frame projection. Thus, the hinge can be referred to as being bi-stable, wherein it is stable when folded and unfolded, and the hinge is biased to automatically move and transition the angular orientations of the frame and arm (e.g., snap) to those positions due to a moment applied by a biasing member when the angle between the frames in the hinge is not at the about 90-degree angle or the about 180-degree angle relative to the projection portion of the frame.

When the eyewear is in the nominal open configuration, a rear facing surface of the frames and a front facing surface of the arm can face each other and can be parallel to each other while contacting each other. In this manner, the hinge for the arm can have minimal space between the frame and the arm, thereby reducing the probability that hair or other debris gets trapped or snagged in the hinge while the frames are open and in the nominal position (e.g., while being worn or while resting on a desktop). Additionally, the outer surfaces surrounding the hinge on the frame and arm can have similar dimensions, curvature, and other surface characteristics to help the hinge more seamlessly visually blend into the eyewear. As used herein, a directional indicator such as a “front” of the wearer of the eyewear or a front or front-facing surface of the eyewear should be understood as being directed in a horizontally forward position relative to the wearer's face or from the front of the lenses of the eyewear with the eyewear being worn and the wearer is sitting or standing upright. This direction may be referred to as a positive Y direction or along a positive Y-axis. Similarly, a “rear” direction should be understood as being directed opposite the front direction (e.g., on the negative Y-axis), and a “right” or “left” direction should be understood as being directed to the right or left of the wearer in that position, respectively (e.g., on the positive and negative sides of an X-axis perpendicular to the Y-axis, respectively). A “vertical” direction should be understood as being oriented up or down from the front, rear, left, or right directions (e.g., on a Z axis perpendicular to the Y and X axes). Thus, parts that are “vertically aligned” should be understood as being aligned in the Z-direction, are aligned when viewed along the Z-axis, or overlap each other and are spaced apart along the Z-axis.

Within the housing of the frame, the hinge can have a cam portion and a cam supporting surface, wherein the cam portion is biased into contact with the cam supporting surface by a biasing member (e.g., a torsion spring). The perimeter of the cam can have some outer surfaces that are flat or flattened relative to other outer transition surfaces of the cam that can contact the cam supporting surface. One flat or flattened surface can engage the cam supporting surface when the arm is in the folded configuration, and another flat or flattened surface can engage the cam supporting surface when the arm is in the open, nominal configuration. Curved or transition surfaces between the flat or flattened surfaces can help the cam slidably rotate against the cam supporting surface to snap, jump, slide, or otherwise transition to the folded or nominal configurations where the flat or flattened surfaces stably engage the cam supporting surface. Thus, the cam and the cam supporting surface of the hinge can provide the bi-stable movement of the eyewear arm. The surfaces of the cam can be designed to respond to a torque applied by the biasing member, wherein with the arm at a transition position between the folded position and the nominal position, application of a moment to the arm toward one of these positions will cause the arm to automatically move (e.g., snap, glide, or otherwise rotate or translate) to that position without need for the initial moment or torque to be constantly applied by a user. Then, once the arm reaches one of the stable positions, it will come to rest in that position and will resist rotation out of that position unless a sufficient moment or torque is applied that overcomes the biasing moment from the biasing member.

The size, shape, and positioning of the arm relative to the frame can be designed to accommodate and comfortably stay positioned on a wide range of users' heads. Additionally, to accommodate an additional range of larger head sizes, the arms of the eyewear can be configured to hyperextend relative to the frame (e.g., an additional few or several degrees) while still providing a comfortable and secure clamping force to the sides on the user's head. When the arm is hyperextended relative to the frame, the cam of the hinge can be pulled away from the cam supporting surface, and the front facing surface of the arm and rear facing surface of the frame can be at least partially offset and spaced apart from each other. For instance, the movement of the arm can form a gap between the front facing surface and the rear facing surface at an inner end of those surfaces relative to the wearer's head and can contact each other at an outer end of those surfaces relative to the wearer's head. In this manner, the front and rear facing surfaces can be nonparallel to each other and can contact each other at a point or line along the surfaces.

A single hinge for the eyewear can be referred to as having dual axes of rotation. The arm can rotate relative to the frame about a first axis of rotation extending through the cam while transitioning between the folded configuration and the nominal configuration. The arm can also rotate relative to the frame about a second axis of rotation extending through a shaft or other pivot axis that is offset from the first axis of rotation, extending through a biasing member of the hinge, and/or positioned laterally external to the perimeter of the cam while transitioning between the nominal configuration and the hyperextended position. Implementing two axes of rotation in this manner can enable the front and rear facing surfaces to sit flush, in contact, and parallel to each other in the nominal configuration, while still allowing hyperextension or folding of the arm when needed.

The eyewear can be configured with electronic components that are positioned in the frame, positioned in the arm, and/or connected through the hinge, such as components in the arm that are electrically connected to components in the frame by an electrical connection extending through the hinge. Some electronic components can include a circuit board or similar substrate or processing and memory device, an energy source (e.g., battery), a light emitter (e.g., a light projector or laser emitter), and a waveguide (e.g., a passive waveguide or active waveguide positioned in, on, or around the lenses of the frames within the field of view of the wearer. In some embodiments, the electrical connection can include a cable or wire that extends through the hinge between the electronic components in the arm and frame. The cable can be hidden within the hinge to protect it from exposure, pinching, bending, or damage that could occur while the arm moves relative to the frame, or due to the cable being accessible to probes or sharp objects external to the arm and frame. Accordingly, the cable can extend through a passage, aperture, or tunnel through the cam, and the cam can act as a partial housing for the cable that limits or completely eliminates this exposure of the cable. A cable passing through the cam aperture can be safely routed from the interior of the arm, through the cam, and into the interior of the frame in a manner that is invisible to an outside viewer, or that only is visible through tiny sub-millimeter-width gaps between these components, and is thereby effectively invisible.

To accommodate the cable routing, the cable can be configured to bend multiple times within the hinge to change its elevation and lateral position in the hinge. At least a portion of the cam aperture can be designed to receive the cable while allowing a large proportion of the movement of the cam between the folded position and the nominal or hyperextended position to avoid any contact with the circumference of the cable. This can help to ensure long cable life due to minimized contact and stress concentration against the sides of the cam aperture, especially where the cam and cable most frequently move.

Eyewear of the present disclosure can include various types of eyeglasses (e.g., glasses with prescription lenses, sunglasses, bifocals, reading glasses, fashion frames, lensless frames, etc.), spectacles, goggles, headsets (e.g., virtual reality, alternate reality, or otherwise modified reality headsets), eye patches, masks (e.g., eye masks, sleep masks, costumes, etc.), and other devices worn on the head. “Electronic eyewear” includes head-mounted devices (e.g., virtual reality, alternate reality, or otherwise modified reality headsets or glasses/spectacles incorporating aspects thereof) that include electronic components such as circuits, electrically-connected sensors, processors, electronic memory devices, electrical energy sources (e.g., batteries), and electronic input and output devices (e.g., displays, switches, buttons, etc.). These devices can be configured to be supported by the sides or cars of the head and the front of the face, such as the bridge of the nose, eyebrows, or eye socket support structures in the wearer's skull and skin. In some embodiments, the eyewear can include electronic components such as output devices (e.g., displays, lights, infrared or ultraviolet emitters, lasers, speakers, haptic vibration or pulse generators, related devices, and combinations thereof), input devices (e.g., microphones, buttons, touch sensors, switches, related devices, and combinations thereof), and other sensors (e.g., thermometers, accelerometers, gyroscopes, related devices, and combinations thereof). In some embodiments, the eyewear can include an onboard power source, such as a battery to provide power to the electronic components. A waveguide can be included and contained in the frame to direct and control the provision of light to the wearer via the lenses of the frames or via a separate viewing location (e.g., a prism positioned in front of the wearer's eyes independent of the main eyeglass lenses).

These and other embodiments are discussed below with reference to the figures. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

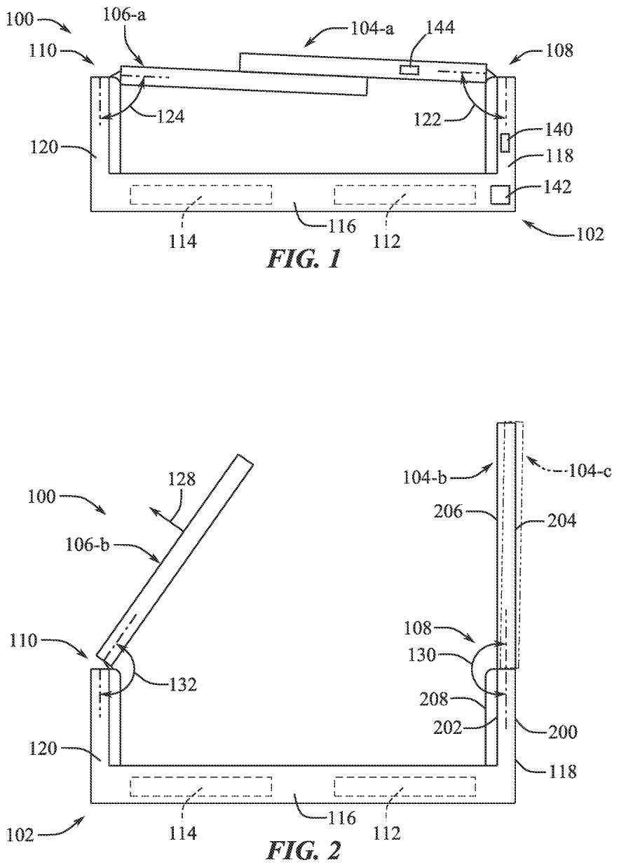

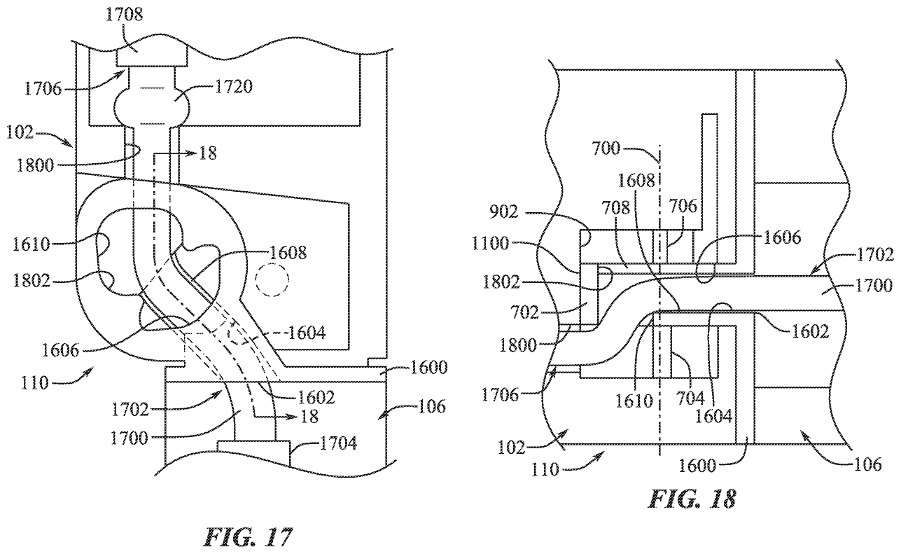

FIGS. 1 and 2 illustrate a top view of a piece of eyewear 100 having a frame 102 and arms 104, 106 rotatably attached to the frame 102 using hinges 108, 110. The frame 102 can include a set of lenses 112, 114 set into a front portion 116 configured to be located in front of a wearer's head. For example, a central part of the front portion 116 can rest on the bridge of the wearer's nose to support the weight of the frame 102. The frame 102 can also include a pair of temple-area-extending projections 118, 120 that extend from the front portion 116 to the front ends of the arms 104, 106 and support, at their rear ends, the hinges 108, 110. The frame 102 can house and contain one or more electronic components such as the output devices, input devices, and other sensors described elsewhere herein. The frame 102 can be substantially rigid so that the output devices, input devices, and other sensors remain oriented stationary relative to each other on the frame 102 as the user wears the eyewear 100 or operates the hinges 108, 110 to move the arms 104, 106. The projections 118, 120 can define a housing for an internal cavity, chamber, or recess configured to hold electronic components and parts of the hinges 108, 110. Some electronic, light-emitting, or light-directing components (e.g., 140) can be positioned in the projection 118, some such components (e.g., 142) can be positioned in the front portion 116 (or can simultaneously overlap the front portion 116 and projection 118), and some such components (e.g., 144) can be positioned in an arm (e.g., 104-a). These components 140, 142, 144 are omitted from FIG. 2 but would still be positioned in their respective locations with the eyewear 100 in the configuration of FIG. 2. In some embodiments, the electronic, light-emitting, or light-directing components 140, 142, 144 can include a light emitter, a projector, a waveguide, an energy source, a circuit board, a processing device, a memory device, a rangefinder, or other components discussed herein and known in the fields of electronic and holographic eyewear, heads-up displays, and similar technologies. In some embodiments, one component 140 includes a light emitter, and another component (e.g., 142 and/or 142 plus 112) includes a waveguide operable to direct light from the light emitter (e.g., toward an eye of the wearer). In embodiments with a waveguide, the eyewear can be used to show information to the wearer on or through at least one of the lenses 112, 114 by reflecting light from a light emitter in the frame 102 using the waveguide so that the light has a more distant appearance to the viewer, thereby permitting the wearer to more comfortably focus the light presented to the eye via the eyewear 100. Some components 140, 142 can be positioned in front of the arms 104, 106. Thus, a first or rear-facing surface of the projection 118 supporting the components 140, 142 can be positioned rearward from the components 140, 142, as shown in FIG. 1. See also FIG. 17 and its related descriptions herein.

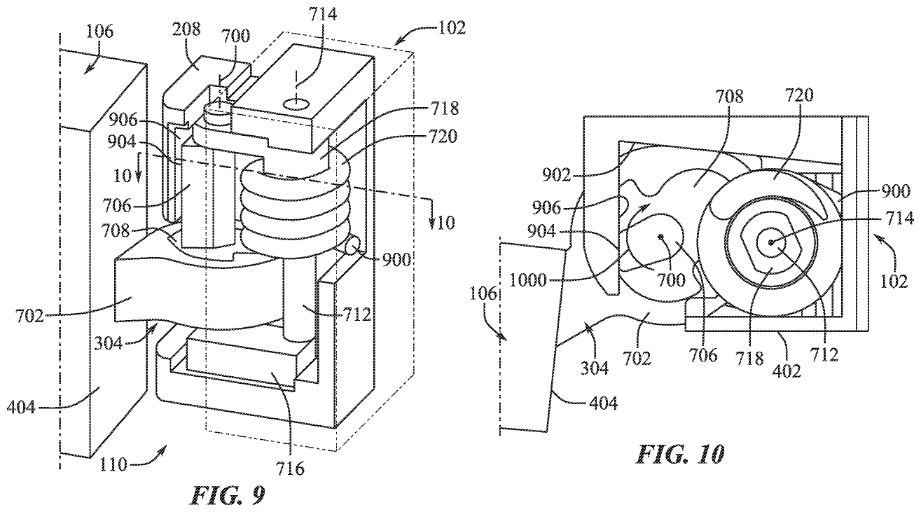

FIG. 1 shows the eyewear 100 with the arms 104, 106 in a folded configuration (signified as 104-a, 106-a) in which the arms 104, 106 have longitudinal axes positioned at about 90-degree angles 122, 124 relative to longitudinal axes of the projections 118, 120. In various embodiments, the angles 122, 124 can be within a range of values, such as, for example, in a range of about 70-degrees to about 105-degrees, in a range of about 75-degrees to about 95-degrees, or about 80-degrees to about 85-degrees. The angles 122, 124 for each arm 104, 106 at positions 104-a, 106-a can be dependent upon which of the arms 104, 106 is folded first, wherein the first arm folds to a smaller angle (e.g., 124) relative to the second arm's angle (e.g., 126). The second sequentially folded arm (e.g., 104) can contact and bias the first sequentially folded arm (e.g., 106) forward toward the front portion 116 of the frame 102. The hinges 108, 110 can include stop surfaces configured to engage each other when the arms 104, 106 are in at least the first folded configuration (e.g., 106-a) so that the arm does not rotate into contact with the frame 102 or lens (e.g., 112). See also FIGS. 9 and 10 and their related descriptions herein.

FIG. 2 shows the eyewear 100 with the arms 104, 106 in respective fully and partially unfolded positions relative to the frame 102. Arm 104 is shown in an open, nominal position (indicated by 104-b), and arm 106 is shown in a partially open position (indicated by 106-b). The hinges 108, 110 can have bi-stable biased movement, wherein the arms 104, 106 are biased into their stable closed positions 104-a, 106-a, or the stable nominal position 104-b (and the corresponding nominal position for 106). Thus, positioning an arm between those positions will bias the arm toward whichever stable position is the nearest. For example, in the position of arm 106-b, the hinge 110 can apply a moment to the arm 106-b biasing it towards its nominal configuration, e.g., along direction 128 in FIG. 2. In the nominal positions, the arms 104, 106 can have their longitudinal axes coaxial with longitudinal axes of the projections 118, 120, wherein an angle between the axes (e.g., 130) is about 180-degrees. In some embodiments, the angle between the axes (e.g., 130) can be within a range of about 175-degrees to about 185-degrees. Thus, in an unstable position, the hinges (e.g., 110) can have an angle between the ranges of the closed positions (e.g., the ranges corresponding to angles 122, 124 above), as indicated by angle 132 which is about 145-degrees (i.e., closer to about 180 than to about 90).

Furthermore, with the arm in a nominal position, the hinge 108 can hyperextend such that the arm moves to a hyperextended position relative to the projection of the frame 102. For instance, as shown in FIG. 2, arm 104 in nominal position 104-b can rotate at hinge 108 to the position of arm 104-c, wherein the angle 130 grows by a value within a range of about 5-degrees to about 10-degrees. In an example embodiment, the angle 130 grows by about 6-degrees to about 9.5-degrees, and in another example, the angle 130 grows by about 6.1-degrees to about 9.2-degrees.

Hyperextension of the arms 104, 106 can allow the eyewear 100 to adapt to the width across the wearer's head (e.g., the width between the otobasion superior on each side of the head or the bieuryonic breadth) so that the arms 104, 106 apply an inward directed force against the wearer's head that keeps the eyewear 100 securely in place. The otobasion superior is located at the top of the car where the car is attached to the side of the head at the temple, and the bieuryonic breadth is the distance between the otobasion superior on each side of the head. According to research measurements, in some embodiments, a hyperextended angle displacement growth of about 6.0 to about 6.1-degrees (relative to a 180-degree nominal position) can apply a clamping force to the head to retain the eyewear 100 to wearers having a bieuryonic breadth up to the 95th percentile of adult humans, and an angle displacement growth of about 9.2-degrees (relative to the 180-degree nominal position) can apply a substantially equal clamping force to wearers having a bieuryonic breadth up to the 99th percentile of adult humans when using the hinges 108, 110. Accordingly, hyperextension of the arms 104, 106 can allow the eyewear 100 to adapt to and be comfortably and securely worn by nearly all adult humans.

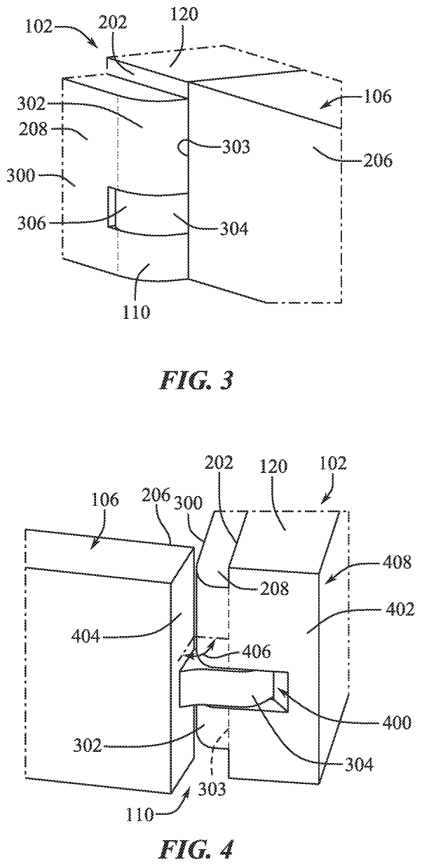

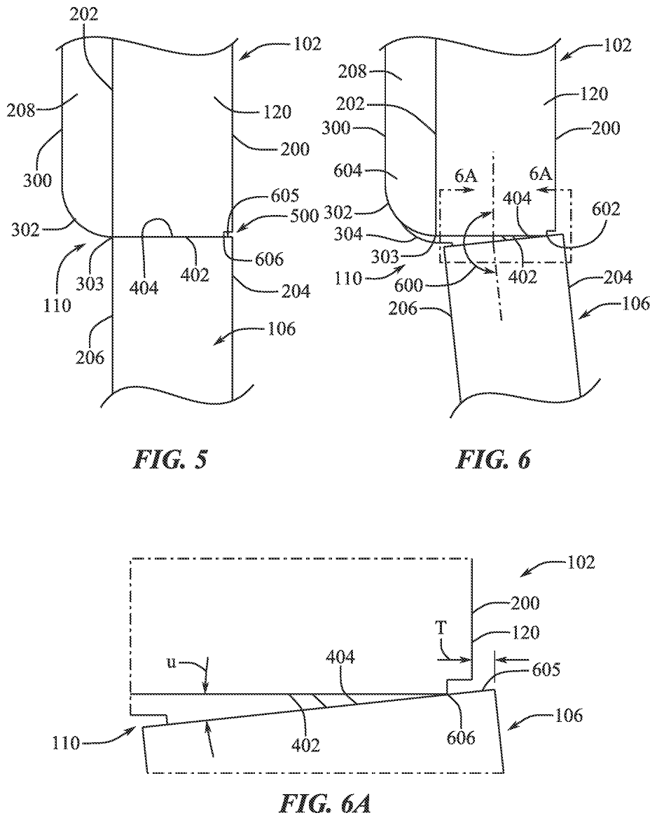

The frame 102 can include an outer surface 200 and an inner surface 202 positioned opposite each other on a projection (e.g., 118). A corresponding outer surface 204 and corresponding inner surface 206 of the arm 106 can be aligned with the outer and inner surfaces 200, 202, respectively, when an arm is in the nominal position. Furthermore, a front facing surface of the arm and a rear facing surface of the projection 118 can be parallel to and contacting each other in the nominal position, as further described in connection with FIGS. 5 and 6. The frame 102 can also include a protruding portion 208 extending inward from the inner surface 202, wherein the inner surface of the protruding portion 208 is laterally offset from the inner surface 206 of the arm 104. Corresponding surfaces 200, 202, 204, 206, and protruding portion 208 can be located at the hinge 110 for arm 106 (in mirrored positioning relative to hinge 108 and arm 104), as described in further detail in connection with FIGS. 3-8, 11-13, and 16-18.

FIG. 3 illustrates a perspective view of the arm 106, frame 102, and hinge 110 that shows the inner surfaces 202, 206 in the nominal position. Hinge 108 and the nearby structures of the arm and frame can appear as a mirror image. The protruding portion 208 can have a flat inner surface 300 aligned substantially parallel to the inner surfaces 202 and 206. The protruding portion 208 can also include a transition surface 302 that gradually transitions inner surface 300 to inner surfaces 202 and 206. For example, the transition surface 302 can form a quarter circle radius when viewed from above. In other embodiments, the transition surface 302 can form a ramp or a flat angle between surfaces 202 and 300. The transition surface 302 can have an end 303 where the frame 102 meets the arm 106. Thus, that end 303 can be aligned with the interface between the frame 102 and arm 106 in a way that minimizes the appearance of seams and gaps between the frame 102 and arm 106.

The hinge 110 can include a hinge component 304 (e.g., a cam or joint member) attached to the arm 106 and movable with the arm. The hinge component 304 can have an inner surface 306 with dimensions in a first horizontal plane that align with (e.g., vertically align with or have matching curvature along the vertical, up-and-down direction) and match dimensions of the transition surface 302 in a second horizontal plane parallel to, and vertically offset from, the first horizontal plane. Thus, for example, the transition surface 302 can have a curvature radius and horizontal position that matches a curvature radius and horizontal (but not vertical) position of inner surface 306 on hinge component 304. In this manner, the arm 106 and frame 102 can have nearby surfaces 202, 206 and 302, 306 flush and aligned with each other for a more seamless aesthetic appearance and in a manner that minimizes the chance that hair or other debris or material will be caught or fall between the frame 102 and arm 106 while they are in the nominal position.

FIG. 4 shows a perspective view of the arm 106, the frame 102, and the hinge 110 with the arm 106 in a folded position 106-a. The hinge component 304 is received into a gap or opening 400 in the transition surface 302 and rear facing surface 402 of the frame 102. The arm 106 is rotated so that its front facing surface 404 no longer contacts rear facing surface 402. An angle 406 measured between the front and rear facing surfaces 402, 404 can be about 90-degrees, or within a range of about 80 degrees to about 100 degrees. The inner surface 206 of the arm 106 can be spaced out of contact with the inner surface 300 of protruding portion 208, thereby preventing and avoiding scratches on the inner surface 300 or arm 106.

FIG. 4 also shows that the hinge 110 conceals and contains any cables, wires, or other electronic conductors extending between the electronic components in the frame 102 and arm 106. Thus, the housings of the frame 102 and arm 106, including hinge component 304, protruding portion 208, and hinge housing 408, can protect and conceal conductors and similar electrical lines to keep them safe from damage and to improve overall durability of the eyewear 100. Gaps between the hinge component 304 and opening 400 can be minimized to reduce the chance that intrusive materials and debris will penetrate into the hinge 110.

FIG. 5 shows a top view of the hinge 110 in the nominal position. The front and rear facing surfaces 402, 404 of the frame 102 and arm 106 are oriented parallel to each other and positioned in close proximity to each other. In some embodiments, the surfaces 402, 404 contact and abut each other in the nominal position. Furthermore, the outer surfaces 200, 204 are parallel and aligned with each other, the inner surfaces 202, 206 are parallel and aligned with each other, and the transition surface 302 is aligned with inner surface 306 on hinge component 304 (thereby rendering the inner surface 306 hidden in this view). Longitudinal axes of the arm 106 and projection 120 can also be coaxial in the nominal position. Accordingly, the longitudinal axes can have an angle between each other of about 180 degrees.

In some embodiments, a small gap or space 500 is defined around at least the perimeters of the front and rear facing surfaces 402, 404, wherein a portion of the frame 102 and arm 106 are spaced out of contact with each other. The space 500 between the frame 102 and arm 106 can be minimized to prevent objects from being trapped at the hinge 110. For example, the space 500 can have a width of about 0.2 millimeters to prevent hair from fitting into the space 500 while the eyewear 100 is being worn. Similarly, in another example embodiment, the space 500 can have a width within a range of about 0.15 mm and about 0.25 mm. Precision alignment of the frame 102 and arm 106 can remove visual distraction at the hinge 110 and make it appear more seamless and less obvious, especially when viewed from a distance. In some cases, the hinge 110 can have contact surfaces internal to the frame 102 and arm 106 that ensure that in the nominal position, the rear and front facing surfaces 402, 404 stay spaced apart from each other to prevent contact between each other to preserve durability and surface finish at and around those front facing surfaces 402, 404.

FIG. 6 shows a top view at the hinge 110 similar to FIG. 5 but with the arm 106 hyperextended relative to the projection 120. Thus, the angle 600 between their longitudinal axes, or central axes normal to the front and rear facing surfaces 402, 404, exceeds the angle of the nominal position of FIG. 5, such as, for example, having a magnitude of about 186 degrees to about 189 degrees. In this position, the front facing surface 404 and rear facing surface 402 can be at least partially separated from each other, such as by being spaced apart at their innermost ends, i.e., near end 303 of transition surface 302. The rear and front facing surfaces 402, 404 can contact each other at a contact point 602 located at or immediately inward from the outer surface 200 of the projection 120. Thus, the hinge 110 can rotate internal to the projection 120 to displace the hinge component 304 in a rearward direction, as shown in FIG. 6, and the front facing surface 404 can slide against the rear facing surface 402 at point 602. The inner workings of the hinge 110 are shown in further detail in connection with FIGS. 7-13.

FIGS. 5 and 6 also show how the first or rear-facing surface 402 and the second or front-facing surface 404 can abut each other with a portion of the front-facing surface 404 being out of contact with the rear-facing surface at the laterally-positioned space 500. In other words, the front-facing surface 404 has a lateral portion 605 that is laterally external to the rear-facing surface 402 (e.g., extends laterally from the laterally-outermost edge 606 of the rear-facing surface 402), as shown in FIG. 5. As illustrated in FIG. 5, the longitudinal axes, or central axes normal to the front and rear facing surfaces 402, 404 are parallel. As the hinge 110 moves to the position of FIG. 6, the proportion of the front-facing surface 404 that is laterally external to the rear-facing surface 402 increases, as indicated in the detail view of FIG. 6A. The lateral portion 605, as measured on the front-facing surface 404 from the laterally-outermost edge 606, comprises a greater proportion of the front-facing surface 404 with the arm hyperextended as compared to the nominal position. Furthermore, the outer surfaces 200, 204 (i.e., lateral side surfaces) of the projection 120 and arm 106 move from being substantially aligned, coplanar, and parallel in the nominal position of FIG. 5 to being laterally offset (e.g., by distance T in FIG. 6A) and non-parallel when the arm 106 is hyperextended, as shown in FIGS. 6 and 6A. As shown in FIGS. 6 and 6A, when in the second position, longitudinal axes, or central axes normal to the front and rear facing surfaces 402, 404 are parallel are translated relative to one another. The angle U between the front-facing surface 404 and rear-facing surface 402 also increases from being substantially zero in the nominal position to being greater than zero/non-zero, as indicated in FIG. 6A.

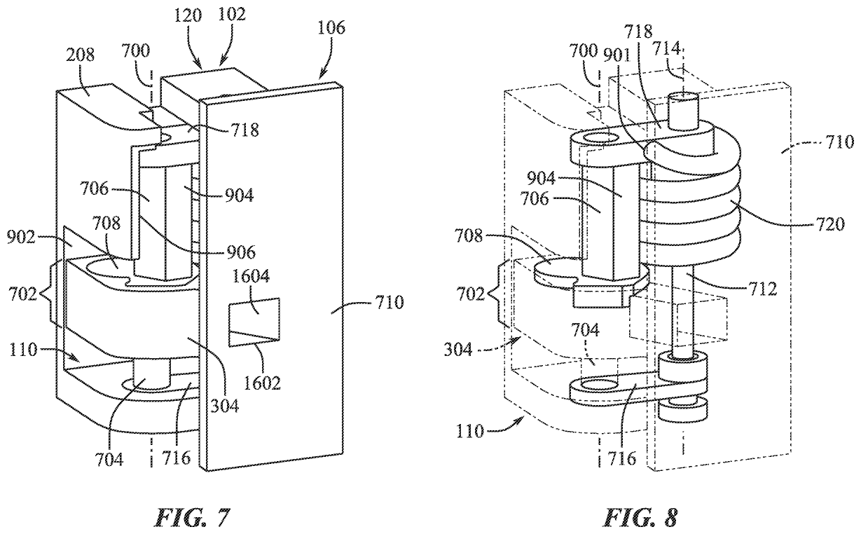

The protruding portion 208 of the frame 102 can include a cover 604 on the exterior of which the surfaces 300, 302 are defined. FIG. 7 shows a perspective view of the frame 102 and arm 106 with the cover 604 removed to reveal internal components of the hinge 110. Accordingly, the protrusion 208 is shown without the cover 604. FIG. 8 is a similar perspective view at the hinge 110 with the frame 102 and arm 106 shown in broken lines to reveal the positioning of other components within the hinge 110. The arm 106 and hinge component 304 can rotate about an axis of rotation 700 extending through the hinge component 304. Accordingly, a user rotating the arm 106 relative to the frame 102 can rotate the hinge component 304 about axis of rotation 700.

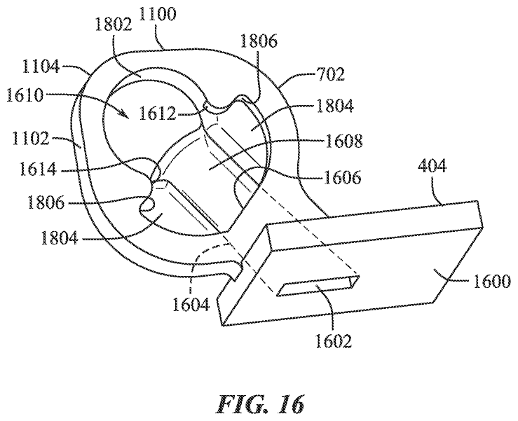

The hinge component 304 can include a cam portion 702 (i.e., a protrusion), a lower shaft portion 704, and an upper shaft portion 706. In some embodiments, the cam portion 702 and lower shaft portion 704 can be a single, integral part, and the upper shaft portion 706 can be a separate part that is attached to the cam portion 702, such as by the upper shaft portion 706 having a lower plate 708 that is welded to the top of the cam portion 702. In some embodiments, the hinge component 304 can include the cam portion 702, lower shaft portion 704, upper shaft portion 706, and lower plate 708 as a single integral piece. The hinge component 304 can also include an arm plate 710 attached to or formed with the housing of the arm 106 and extending from the cam portion 702. The arm plate 710 can have a front facing surface used as the front facing surface 404 described above. Accordingly, the hinge component 304 and arm plate 710 (i.e., end block 1600 in FIG. 16) can all rotate about axis of rotation 700 in response to application of a moment to the arm 106 relative to that axis of rotation 700.

The hinge 110 can also have a secondary shaft 712 shown in FIG. 8. The secondary shaft 712 can define a second axis of rotation 714 about which a lower linkage 716 and an upper linkage 718 are rotatable. The secondary shaft 712 is a fixed to the frame 102 and is not translatable relative to the frame 102, unlike the first axis of rotation 700. In some embodiments, the secondary shaft 712 is rotatable relative to the frame 102 using bearings at the ends of the secondary shaft 712, and in some embodiments, the secondary shaft 712 is not rotatable relative to the frame 102, such as by the ends of the secondary shaft 712 being adhered or welded to the frame 102. In that case, the linkages 712, 718 can be rotatable about the shaft 712 (e.g., using bearings). The secondary shaft 712, linkages 716, 718, and biasing member 720 can be collectively referred to as a rotation assembly. The rotation assembly can, in some embodiments, also include the cam portion 702 and its shafts 704, 706 and plate 708.

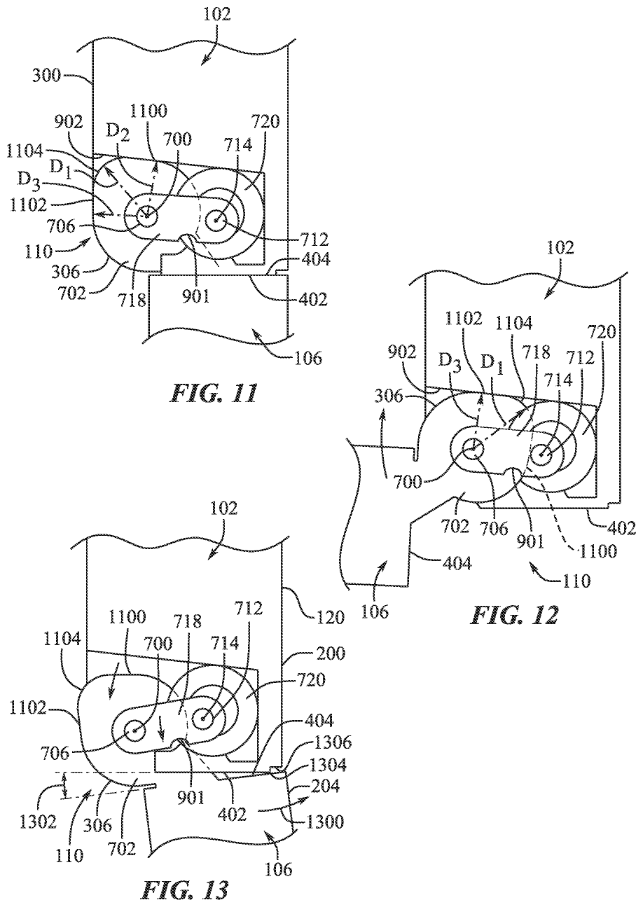

A biasing member 720 is positioned around the secondary shaft 712 within the hinge 110. FIGS. 8 and 9 show the biasing member 720 as a coiled torsion spring having a first end 900 engaged with an inner surface of the frame 102. FIG. 9 shows the hinge 110 in a folded configuration and with portions of the frame 102 shown in broken lines to reveal the internal components. A second end of the biasing member 720 engages or is attached to the upper linkage 718 (e.g., at upper engagement point 901 in FIG. 8) and is thereby configured to apply a moment to the upper linkage 718 to bias the upper linkage to rotate about the second axis of rotation 714. This moment is transferred via the secondary shaft 712 to the lower linkage 716 as well. Thus, the biasing member 720 biases the upper and lower linkages 718, 716 to rotate the hinge component 304 about the second axis of rotation 714 and into contact with a support surface 902, as indicated in FIG. 7. Specifically, the cam portion 702 of the hinge component 304 contacts the support surface 902, as shown and described in more detail in connection with FIGS. 11-13 below. The moment applied by the biasing member 720 can be overcome by the user of the eyewear 100, such as when the hinge 110 is hyperextended, and the arm 106 and hinge component 304 can thereby be pulled out of contact with the support surface 902 at least until the moment applied by the wearer is released, and the moment of the biasing member 720 returns the hinge component into contact the support surface 902.

As shown in FIG. 9, the hinge 110 can be operated into a folded position wherein the arm 106 is rotated about the first axis of rotation 700 relative to the nominal position shown in FIGS. 7 and 8. The movement of the arm 106 relative to the frame 102 can be limited by contact between hard stop surfaces on the upper shaft portion 706 and the frame 102. The shaft hard stop surface 904 (i.e., a third flat surface of the upper shaft portion 706 of the cam portion 702) of the upper shaft portion 706 contacts a frame hard stop surface 906. These hard stop surfaces 904, 906 can prevent the arm 106 from over-rotating when folded and coming into contact with a lens 112, 114 or front portion 116 of the eyewear 100.

FIG. 10 shows a top section view of the configuration of the hinge 110 shown in FIG. 9 as taken through section lines 10-10. FIG. 10 indicates where the hard stop surfaces 904, 906 engage each other in the upper area of the hinge 110. The hard stop surfaces 904, 906 are flattened and are configured to contact face-to-face and parallel to each other to limit rotation of the arm 106 about the first axis of rotation 700 in the direction of arrow 1000. The hard stop surface 904 of the arm 106 faces laterally inward (i.e., toward the center of the frame 102), and the hard stop surface 906 of the frame 102 faces laterally outward (i.e., away from the center of the frame 102). The hard stop surfaces 904, 906 do not prevent the hinge 110 from rotating opposite to the direction of arrow 1000 (i.e., going back toward the nominal position).

FIGS. 11-13 show a series of section views of the hinge 110 showing how the frame 102, arm 106, linkage 718, shafts 706, 712, and biasing member 720 interact. Some features are omitted or simplified to improve clarity. In FIG. 11, the arm 106 is in the nominal position relative to the frame 102. In FIG. 12, the arm 106 is in the folded position relative to the frame 102. In FIG. 13, the arm 106 is hyperextended relative to the frame 102. The cam portion 702 has at least two laterally-facing flat surfaces 1100, 1102 on its outer perimeter that are separated from each other by a change in surface angle at a curved transition surface 1104. The inner surface 306 of the cam portion 702 is positioned adjacent to and adjoining flat surface 1102 opposite the transition surface 1104. In the nominal configuration, the cam portion 702 has one flat surface 1100 engaging and abutting the flat cam support surface 902 of the frame 102, as shown in FIG. 11. The other flat surface 1102 is aligned with flat inner surface 300 of the frame 102 at the protruding portion 208. The rear and front facing surfaces 402, 404 are abutting each other, as described in greater detail in connection with FIG. 5.

The arm 106 is stable relative to the frame 102 in the nominal position of FIG. 11 due to the shape of the cam portion 702 and due to the cam portion 702 being biased into contact with the cam support surface 902 by the linkage 718 and biasing member 720. The biasing member 720 applies a moment or torque to the linkage 718 which is transferred to the cam portion 702 via the shaft 706. The width of the flat surface 1100 and its proximity to the first axis of rotation 700 ensures that any rotation of the cam portion 702 would require application of an additional moment or torque to the arm 106 to rotate the arm 106 toward the folded or hyperextended positions, and that additional moment or torque would need to overcome the friction of the cam portion 702 against surface 902 and the biasing force of the biasing member 720 to rotate the first axis of rotation 700 away from support surface 902. In other words, in order to rotate the cam portion 702 from the position of FIG. 11 to the position of FIG. 12 (with surface 1102 in contact with the cam support surface 902), the cam portion 702 would need to rotate away from the cam support surface 902 (e.g., with transition surface 1104 contacting the cam support surface 902, which is at a larger radial distance D₁ from the axis of rotation 700 as compared to the radial distances D₂, D₃ of surfaces 1100, 1102). Rotating away from the cam support surface 902 would require at least partially overcoming the biasing moment and friction to make that move. Once reaching a position where transition surface 1104 is contacting the cam support surface 902, the biasing moment can cause the cam portion 702 (and arm 106) to “snap” or otherwise automatically move back to the position of FIG. 11 by sliding surface 1104 in contact with the cam support surface 902 (if the contact point between the cam portion 702 and cam support surface 902 on transition surface 1104 is still nearer to flat surface 1100 relative to the larger radial distance D₁ point) or to snap or otherwise automatically move to the position of FIG. 12 by sliding in contact with the cam support surface 902 (if the contact point between the cam portion 702 and cam support surface 902 on transition surface 1104 is nearer to flat surface 1102 relative to the larger radial distance D₁ point).

Notably, the second axis of rotation 714 and shaft 712 remain stationary as the arm 106 moves, but the first axis of rotation 700 and shaft 706 are capable of revolving about the second axis of rotation 714 as needed. Thus, the first axis of rotation 700 can move away from the cam support surface 902 as the cam portion 702 rotates (e.g., when the cam portion 702 has transition surface 1104 in contact with cam support surface 902). In this manner, the hinge 110 can be referred to as a dual-axis hinge or a hinge having multiple internal axes of rotation that enable pivoting movement of parts using a linkage between a first axis of rotation (e.g., 700) and a second axis of rotation (e.g., 714).

As shown in FIG. 12, the arm 106 can be pivoted about the first axis of rotation 700 to a position with flat surface 1102 in contact with cam support surface 902. Again, the arm 106 is biased into this position by the biasing member 720 via the linkage 718. The cam portion 702 resists movement away from this position (thereby requiring application of a moment or torque by the user) due to the radial distance D₃ being less than the radial distance D₁ and friction between the cam portion and support surface. The cam portion 702 therefore is biased toward sliding the transition surface 1104 laterally outward (i.e., to the right side in FIG. 12) to keep the flat surface 1102 as nearly as possible against the cam support surface 902.

FIG. 13 shows the hinge 110 in a hyperextended position, wherein a moment or torque (e.g., along direction 128 while the hinge 110 is in the nominal position) has been applied to the arm 106 to rotate it laterally outward. This movement is about axis of rotation 714 and along the direction of arrow 1300). As shown here, the outward rotation pulls the flat surface 1100 away from the cam support surface 902 as the cam portion 702 rigidly moves with the arm 106. The front facing surface 404 and rear facing surface 402 are positioned at a non-zero angle 1302 relative to each other, wherein the base of the angle is positioned at a contact point 1304 where the front facing surface 404 contacts a laterally outermost edge of the rear facing surface 402.

The outer surface 204 of the arm 106 is entirely laterally offset from the outer surface 200 of the side projection 120 of the frame 102 due to the center of rotation of the arm 106 being at axis 714 and not at point 1304. In some embodiments, the projection 120 includes a rear recess or groove 1306 giving space for the outer edge of the front facing surface 404 to move without scraping against the rear facing surface 402 or outer surface 200 lateral to contact point 1304. The rotation of the linkage 718 rotates the first axis of rotation 700 and shaft 706 about the second axis of rotation 714, and the shafts 704, 706 move the cam portion 702 and arm 106 along with the first axis of rotation 700.

The biasing member 720 applies a biasing moment or torque to the linkage 718 which in turn transfers the moment to the shaft 706, cam portion 702, and arm 106. Accordingly, when a wearer of the eyewear places the eyewear 100 on their head and contact between the sides of the head and the arms 104, 106 pushes the arms laterally outward, the biasing member 720 of each hinge 108, 110 applies a clamping force to the sides of the head to help keep the eyewear secured to the wearer. Additionally, when the wearer takes off the eyewear, the biasing moment can drive the arms 104, 106 from the hyperextended configuration to the nominal position, thereby granting the eyewear 100 an orderly, visually aligned appearance and minimal gaps at the hinges 108, 110 for intrusion of unwanted contaminants or blockages.

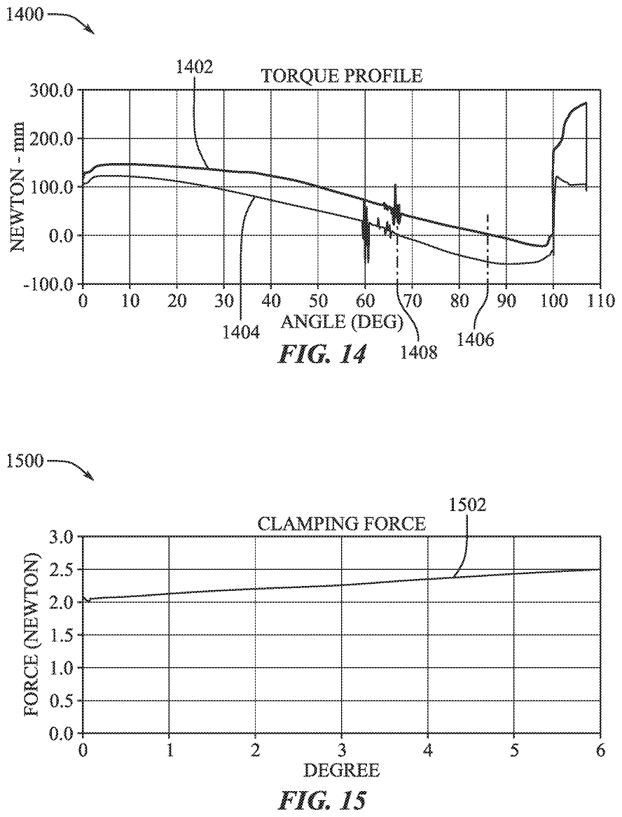

FIG. 14 shows a chart 1400 of torque profiles (i.e., moment profiles) of elements of a hinge of an embodiment of the present disclosure. The hinge can have a displacement angle (as indicated along the horizontal axis) and can apply a biasing moment (as indicated along the vertical axis) at each angle. At an angle of about zero degrees of angular displacement from the folded position, the first torque profile 1402 shows that a biasing member (e.g., 720) of the hinge (e.g., 108 or 110) applies about 120 Newton-millimeters of force to the hinge to hold the hinge in the folded position. For example, the moment applied to a cam portion 702 would hold the second flat surface 1102 against surface 902 in FIG. 12.

As the angular displacement from the folded position increases (i.e., the hinge is unfolded toward the nominal position), the moment applied by the biasing member gradually changes along profile 1402, peaking at about 140 N-mm, until declining to a point where it turns from a positive value to a negative value (i.e., at point 1406, which corresponds to about 86-87 degrees of angular displacement). At that point 1406, the now-negative moment causes the hinge to automatically move to the nominal position as the transition surface 1104 of the cam is passed at the outer surface where distance D₁ is measured. The moment quickly switches back to a positive value at about 100 degrees of angular displacement when a new flat cam surface (i.e., 1100) rests against the cam support surface (i.e., 902), and the hinge is held at rest in the nominal position.

Second torque profile 1404 shows this process happen in reverse, wherein angular displacement at zero degrees is shown from the nominal position rather than from the folded position. Thus, in the nominal position, i.e., angular displacement of zero for second profile 1404, the biasing member applies a moment of about 100 N-mm that holds the arm in the nominal position. As the arm is rotated to about 68 degrees of angular displacement toward the folded position, the biasing moment slightly increases then gradually decreases until it switches from a positive moment to a negative moment at point 1408. This negative moment causes the cam to turn on its own and to automatically move (e.g., snap or otherwise transition its movement without application of additional force by the user) the arm to the folded position (i.e., with flat surface 1102 engaging cam support surface 902). At about 100 degrees of angular displacement away from the nominal position, the moment returns to a positive value that holds the cam and arm in place in the folded position. From that point, the first profile 1402 would be followed again when the eyewear 100 are re-opened.

FIG. 15 is a chart 1500 illustrating clamping force applied by the biasing member (e.g., 720) of the eyewear while the hinge (e.g., 108, 110) is being hyperextended. In this case, the profile 1502 shows a force to angular displacement relationship. At zero degrees, i.e., the nominal position of the arm relative to the frame, a clamping force (i.e., a force that would be applied to the side of the wearer's head with the eyewear arms contacting the sides of the head) is about 2 Newtons. As the arm is hyperextended, angular displacement in hyperextension (e.g., growth of angle 600 in FIG. 6) causes the biasing member to gradually increase clamping force proportionally (or substantially proportionally) to the angular displacement. The magnitude of change in the force value (i.e., an additional about 0.5 N per 6 degrees of displacement) is small enough that it would be difficult to perceive by a wearer having a wider head than another wearer. Accordingly, the eyewear can apply a similar level of clamping force to heads having a wide range of widths at which contact with the arms is made. The rate of change of force to angular displacement of profile 1502 can be kept small by using a biasing member having high stiffness and that acts as an at least substantially linear spring and, potentially, a constant force spring.

In order to optimize usage of internal space in the frame 102 and arm 106, electronic components can be spaced apart and positioned the frame 102 and arm 106. Electrical connectors such as cables can be used to link the electronic components, but cables can be relatively fragile as compared to other components, especially when they are configured to pass through a hinge that subjects them to bending and potentially exposes them when the hinge is operated. FIG. 16 is a top perspective view of the cam portion 702 of the hinge 110 shown in FIGS. 11-13. The cam portion 702 is integrally formed with or attached to an end block 1600 of the arm 106. The end block 1600 can include a rear opening 1602 that opens into a cavity in the arm 106 in which an arm electronic component is located. See FIG. 18. The rear opening 1602 can provide access to a side-enclosed, tunnel-like passage 1604 through the end block 1600 that opens into the cam portion 702 at a front opening 1606. The front opening 1606 opens to a groove, internal channel, or recess 1608 in the top surface of cam portion 702 which has an aperture 1610 at its front end.

FIG. 17 shows a top view of the cam portion 702 positioned next to the frame 102. A cable 1700 can extend through the cam portion 702 by passing from the rear opening 1602 through the passage 1604, past the front opening 1606, within the recess 1608, and downward through the aperture 1610 at the front end. A rear end 1702 of the cable 1700 can be electrically connected to an arm electronic component 1704 in the arm 106, and a front end 1706 of the cable 1700 can be electrically connected to a frame electronic component 1708 in the frame 102. Accordingly, the cable 1700 can provide electrical communication across the hinge 110 and between electronic components of the frame 102 and arm 106. The electronic components 1704, 1708 can include electronic components disclosed elsewhere wherein, such as the electronic components (e.g., 140, 142, 144) of FIG. 1.

The cable 1700 can have a series of bent portions along its length between the rear end 1702 and the front end 1706. In some embodiments, the cable 1700 can have an S-shaped top profile, as shown (rotated counterclockwise 90 degrees) in FIG. 17, wherein the cable 1700 has at least two lateral bends at different points along its length as it passes through the hinge 110 (e.g., as it passes through cam portion 702). Each of the bends can have roughly the same angular magnitude, but can keep the cable 1700 ends 1702, 1706 substantially parallel to each other due to being supplementary to each other as measured from one lateral side of the cable 1700. In some embodiments, the cable 1700 bends laterally inward (i.e., horizontally toward the center of the frame 102) near the rear end 1702 and bends laterally outward (i.e., horizontally away from the center of the frame 102) near the front end 1706, or vice versa. By passing through the cam portion 702, the cable 1700 can be hidden and protected by the shell formed by the outer surfaces of the cam portion 702 in all operational configurations of the hinge 110 (i.e., in the folded, nominal, and hyperextended configurations). See, e.g., FIGS. 3-6. The cable 1700 can therefore be protected and have a longer service life.

FIG. 17 also shows that the cable 1700 can have a flexible seal 1720 positioned near the front end 1706 that is configured to engage a mouth of a frame passage 1800 on the frame 102. The flexible seal 1720 can include an elastically flexible material (e.g., rubber or plastic) that longitudinally lengthens or shortens with movement of the cable 1700 to seal the frame passage 1800 against intrusion of fluids (e.g., water) so that fluids in the hinge 110 do not enter the frame 102. The flexible seal 1720 can change its length along a longitudinal axis of the cable 1700 and can thereby accommodate the movement of the cable 1700 without causing the cable 1700 to bend or buckle where it is sealed at the frame passage 1800. The flexible seal 1720 can include a tubular feature wrapped around the cable 1700 or can be formed as part of the sheathing of the cable 1700 and attached firmly to (e.g., pressed against and in sealing contact with) the opening at the front end of the frame passage 1800.

FIG. 18 shows a side section view of the hinge 110 as taken through section line 18-18 in FIG. 17. FIG. 18 therefore shows a side view of the routing of the cable 1700 through the hinge 110 along an outward-facing direction. The cable 1700 has a rear end 1702 that enters the rear opening 1602, extends forward through passage 1604 out of front opening 1606, across recess 1608, and down through aperture 1610 into a frame passage 1800 that leads to the frame electronic component 1708. As shown here, the cable 1700 makes a downward bend where the recess 1608 meets the aperture 1610 and makes a supplementary upward bend at the bottom of the aperture 1610 before entering the frame passage 1800. Thus, the rear and front ends of the cable 1700 are substantially parallel despite changing elevation within the hinge 110.

FIG. 18 also shows that the cam portion 702 has its upper shaft 706 and lower shaft 704 aligned adjacent to the aperture 1610, and the axis of rotation 700 of the cam portion 702 extends through the cable 1700. The axis of rotation 700 also extends through the shafts 704, 706 and through the recess 1608. Both shafts 704, 706 brace the cam portion 702 and prevent it from tilting in the opening 400 as the hinge 110 is operated, thereby reducing or eliminating scraping or binding between the cam portion 702 and the opening 400. For example, the shafts 704, 706 help prevent rotation of the arm 106 about its longitudinal axis due to each shaft being positioned on opposite vertical sides of the flat surfaces 1100, 1102 of the cam.

Movement of the hinge 110 bends the cable at the recess 1608. The movement of the cable 1700 and its contact with the sides of the recess 1608 and aperture 1610 can cause stress on the cable 1700, especially over a large number of folding and unfolding cycles. To mitigate this stress, the aperture 1610 can be sized and configured to avoid contact with the cable 1700 for a majority of the range of motion of the arm 106 relative to the frame 102. For example, the aperture 1610 can have a width sufficient to avoid contact with the cable 1700 at least until about 70 degrees of rotation of the hinge from the nominal position toward the folded position takes place, wherein 70 degrees is a substantial majority of the overall approximately 85-100 degrees of total angular displacement taken in a complete folding movement. Durability of the cable 1700 can also be supplemented by including curved mandrel surfaces 1612, 1614 at the interface between the recess 1608 and the aperture 1610, wherein the cable 1700 can laterally come into contact with a curved mandrel surface and can have its radius of bending limited by the surface radius of the mandrel surface against which it makes contact.

FIG. 18 also shows in cross-section the cam portion 702 with the lower plate 708 positioned inserted into a top opening 1802 of the cam portion 702 that is positioned over the recess 1608 and aperture 1610. The cam portion 702 and lower plate 708 can in some embodiments be formed as a single integral piece. In the embodiment shown in FIG. 18, the lower plate 708 is assembled to the cam portion 702 and affixed (e.g., adhered or welded) into place so that the cam portion 702 and lower plate 708 act as a single rigid structure relative to each other. Using a two-piece assembly in this manner can improve manufacturability of the cam portion 702, particularly with respect to the creation of the aperture 1610 and recess 1608 by techniques such as milling or laser ablation. The top opening 1802 can have a splined perimeter, wherein the perimeter extends partially around the perimeter of the aperture 1610 and partially around two partial recesses 1804 (see FIG. 16) which have hook-shaped profile portions 1806. The lower plate 708 can likewise include a splined perimeter configured to be inserted into the top opening 1802 and resting on the partial recesses 1804 with its own hook-shaped profile sections fitting into the portions 1806, as shown, for example, in FIGS. 7-10. The unique, irregular shape of the splined profile enables secure, single-orientation attachment between the cam portion 702 and the lower plate 708 and helps ensure a high amount of torque transfer between the parts without jeopardizing the bond or weld made upon assembly. The splined profile also improves and cases manufacturability of the hinge component 304.

Personal information data can be used to implement and improve on the various embodiments described herein provided that it is gathered pursuant to authorized and well established secure privacy policies and practices that are appropriate for the type of data collected. The technology detailed above is not, however, rendered inoperable in the absence of such personal information data.

It will be understood that the details of the present systems and methods above can be combined in various combinations and with alternative components. The scope of the present systems and methods will be further understood by the following claims.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. Electronic eyewear, comprising:
a frame containing a light emitter and a waveguide to direct light from the light emitter, the frame having a first surface;
an arm having a second surface; and
a hinge pivotally joining the frame and the arm, the hinge comprising a first axis of rotation and a second axis of rotation.

2. The electronic eyewear of claim 1, further comprising:
a first central axis normal to the first surface; and
a second central axis normal to the second surface;
wherein with the hinge in a first open position, the first surface is parallel to the second surface and the first central axis is parallel to the second central axis; and
wherein with the hinge in a second open position, the first surface is non-parallel to the second surface and the second central axis is translated relative to the first central axis.

3. The electronic eyewear of claim 1, wherein the hinge comprises a first portion inserted into a second portion, the first portion having a first curved exterior surface, and the second portion having a second curved exterior surface;
wherein the first curved exterior surface is vertically aligned with the second curved exterior surface when the hinge is in the first open position.

4. The electronic eyewear of claim 1, wherein the hinge further comprises a spring member biasing the rear-facing surface and the front-facing surface to the first open position from the second open position.

5. The electronic eyewear of claim 1, wherein:
the hinge rotates about the first rotation axis when moving from a folded position to a first open position; and
the hinge rotates about the second rotation axis when moving from the first open position to a second open position.

6. The electronic eyewear of claim 1, wherein the hinge includes a torque profile configured to automatically move to the folded position and to automatically move to the first open position.

7. The electronic eyewear of claim 5, wherein the hinge comprises:
a cam having a first flat surface and a second flat surface; and
a support surface;
wherein the first flat surface engages the support surface when the hinge is in the folded position; and
wherein the second flat surface engages the support surface when the hinge is in the first open position.

8. The electronic eyewear of claim 7, wherein the first flat surface and the second flat surface are out of contact with the support surface when the hinge is in the second open position.

9. A hinge for glasses, comprising:
a first hinge portion defining a cam support surface and a rotation assembly, the rotation assembly comprising a spring, a shaft, and a linkage; and
a second hinge portion defining a cam rotatably coupled with the linkage and having a first flat surface and a second flat surface;
wherein:
the spring is configured to bias the cam to rotate about the shaft toward the cam support surface via the linkage;
the cam is rotatable between a first position and a second position;
the first flat surface engages the cam support surface in the first position; and
the second flat surface engages the cam support surface in the second position.

10. The hinge of claim 9, wherein the cam comprises a second shaft coupled to the linkage.

11. The hinge of claim 9, wherein:
the rotation assembly further comprises a second linkage rotatably coupled with the cam; and
the linkage is positioned opposite the first and second flat surfaces relative to the second linkage.

12. The hinge of claim 9, wherein the cam comprises a hard stop surface configured to stop rotation of the cam relative to a stop surface of the first hinge portion.

13. The hinge of claim 9, wherein the cam comprises an internal channel, wherein a cable is routable between the first and second hinge portions through the internal channel.

14. The hinge of claim 9, wherein the cam is rotatable about the shaft to a third position with the first and second flat surfaces spaced away from the cam support surface.

15. The hinge of claim 14, wherein the spring biases the first and second flat surfaces toward the second position from the third position.

16. Electronic glasses, comprising:
an arm structure including a first electronic component, a protrusion, and an aperture defined through the protrusion;
a frame structure having a second electronic component and defining a recess receiving the protrusion, wherein the protrusion is rotatable relative to the recess between a folded position and an unfolded position; and
a cable connecting the first electronic component and the second electronic component, the cable being contained by the aperture and the recess in the folded position and in the unfolded position.

17. The electronic glasses of claim 16, further comprising a flexible seal;
wherein the cable comprises a longitudinal axis; and
wherein the cable is configured to translate along the longitudinal axis to flex the flexible seal.

18. The electronic glasses of claim 16, wherein:
the protrusion includes a curved surface;
the frame structure includes a rounded external surface; and
the curved surface and the rounded external surface have matching curvature in the unfolded position.

19. The electronic glasses of claim 16, wherein the cable bends at least twice within the aperture.

20. The electronic glasses of claim 16, wherein:
the aperture comprises a recess portion;
the cable is positioned in the recess portion; and
a rotation axis of the protrusion extends through the recess portion.
